(19) United States
(12) Patent Application Publication
(10) Pub. No.: US 2026/0074960 A1
(43) Pub. Date: Mar. 12, 2026

(54) ARTIFICIAL INTELLIGENCE VARIOUS MODE MEASUREMENTS PROCEDURE

(71) Applicant: InterDigital Patent Holdings, Inc., Wilmington, DE (US)

(72) Inventors: Tezcan Cogalan, London (GB); Yugeswar Deenoo Narayanan Thangaraj, Chalfont, PA (US); Oumer Teyeb, Montreal (CA); James Miller, Northport, NY (US); Filipe Conceicao, London (GB)

(21) Appl. No.: 19/102,509

(22) PCT Filed: Aug. 7, 2023
(86) PCT No.: PCT/US2023/029639

§ 371 Date: Feb. 10, 2025

Related U.S. Application Data
(60) Provisional application No. 63/395,994, filed on Aug. 8, 2022.

(51) Int. Cl. H04L 41/16; H04L 43/062

(52) U.S. Cl. CPC H04L 41/16; H04L 43/062

(57) ABSTRACT

Procedures, methods, architectures, apparatuses, systems, devices, and computer program products directed to artificial intelligence-specific idle/inactive/connected mode measurements procedure. In an embodiment, a method implemented by a wireless transmit receive unit (WTRU), the method comprising: receiving, from a network, a first message comprising a configuration about AI/ML model training and associated measurements and logging periodicity; performing minimization of drive test (MDT) measurements; selecting an AI/ML model for training based on the based on the first message; training the selected AI/ML model based on MDT measurements; and in response to accuracy of the trained model above a configured accuracy threshold, triggering transition to connected state and reporting to the network the trained AI/ML model identity and AI/ML model parameters.

### CROSS-REFERENCE TO RELATED APPLICATIONS

The present application claims the benefit of U.S. Provisional Ser. No. 63/395,994 filed Aug. 8, 2022, which is incorporated herein by reference.

### TECHNICAL FIELD

The present disclosure is generally directed to the fields of communications, software and encoding, including, for example, to methods, architectures, apparatuses, systems directed to artificial intelligence-specific idle/inactive/connected mode measurements procedure.

### BACKGROUND

For many Artificial intelligence/Machine learning (AI/ML) tasks, the fragmented data collected by mobile devices may be essential for training a global model. For some AI/ML model training and model inference operations, input data may need to be consecutive and be a time series of information per certain granularity. In some cases, task and environment variations may require a different AI/ML model to perform the same feature prediction. Therefore, another training and inference cycle may be needed with a different data set that represents the new environment variations. The current measurement reporting mechanisms may support AI/ML at network for training purposes. As the provided measurements data would be either non-consecutive or contain past measurements, the network may need to perform AI/ML training operation first, and then, performs the prediction/inference operation. Therefore, the legacy measurement procedures may not enable the network to perform predictions immediately after a wireless transmit/receive unit (WTRU) provided the measurements data. Nowadays, computation resources used in mobile devices can afford the execution of AI/ML operations at some capacity. In order to improve the AI/ML operations with these capable devices along with the existing or new set of measurements, the network may distribute the training operation to WTRUs that are capable to perform AI/ML operations. The network then may request WTRUs to provide trained model parameters that can be immediately aggregated by the network to have a global, use case-specific or area-specific AI/ML models which can be immediately used for prediction/inference by the network for the WTRUs that have the same or similar environment variations.

Accordingly, there is a need to enhance the measurements and logging procedure to enable the network to efficiently utilize the available measurements at the WTRU.

### SUMMARY

In an embodiment, a method implemented by a wireless transmit receive unit (WTRU) may comprise transmitting AI/ML capability information including available AI/ML models, AI/ML models accuracy level, computation capability (e.g., FLOPs) for training and/or inference, AI-dedicated memory capacity (e.g., for training data and/or model storage). The method may possibly comprise receiving AI/ML model from the network. The method may further comprise receiving a configuration about AI/ML model training and associated measurements and logging periodicity, wherein the configuration may comprise any of report type, indication of AI/ML model(s) (e.g., already available or network configured), selection criteria (e.g., based on mobility scenario such as low-mobility and at-cell-edge, etc.), input/output parameters, loss/reward function, accuracy threshold level, training data configuration (e.g., minimum dataset size for training), conditional logging configuration (e.g., based on AI/ML model accuracy), and conditional training configuration (e.g., based on specific location). The method may comprise performing MDT measurements, wherein performing MDT measurements may comprise logging legacy MDT measurements and or skipping MDT measurement logging occasion when one or more of the following conditions are met: (i) AI/ML model is still in training phase with the existing logged MDT measurements data; (ii) the (e.g., immediate/current) measurements are used to validate the trained AI/ML model or (iii) the trained AI/ML model achieves the configured accuracy threshold level. The method may further comprise selecting an AI/ML model for training based on the indication of AI/ML model and configured selection criteria. Possibly, if logged MDT measurement data meets training data configuration (e.g., dataset volume is larger than the configured minimum dataset size for training, batch size, etc.)-and if the conditional training criteria (e.g., WTRU is at specific location) is met, the method may perform training of the AI model and/or logging AI/ML model parameters. Upon completion of the training procedure, the method may comprise performing one or more of the following actions: if the model accuracy level is above the configured accuracy threshold level, then triggering transition to connected state, reporting AI/ML model identity and AI/ML model parameters. In addition, if the model accuracy level is above the configured accuracy threshold level, the method may further comprise reporting logged validity time of the trained AI/ML model that achieves the given accuracy threshold level (e.g., trained AI/ML models in low-/high-mobility scenarios may achieve the given threshold level for a certain time window). If the model accuracy level is equal or below the configured accuracy threshold level, the method may comprise reporting logged MDT measurements; maximum AI/ML model accuracy level achieved during training.

In another embodiment, a method implemented by a remote wireless transmit receive unit (WTRU) may comprise enabling the WTRU to receive and store vendor-specific and/or network-provided AI/ML model(s). The method may comprise transmitting AI/ML capability information including available AI/ML models, their accuracy level, computation capability (e.g., FLOPs) for training and inference, AI/ML-dedicated memory capacity (e.g., for training data and/or model storage). Possibly, the method may comprise receiving AI/ML model from the network. The method may further comprise receiving a configuration about AI/ML model validation/inference and associated measurements and logging periodicity, wherein the configuration may comprise any of reporting type, indication of AI/ML model(s) (e.g., already available or network configured), selection criteria (e.g., based on mobility scenario such as low-mobility and at-cell-edge, etc.), input/output parameters, loss/reward function, accuracy threshold level, conditional logging configuration (e.g., based on AI model accuracy), and conditional inference configuration (e.g., based on specific location). The method may comprise performing MDT measurements. Performing MDT measurement may comprise logging legacy MDT measurements and/or skipping MDT measurement logging occasion when one or more of the following conditions are met: (i) the (e.g., immediate/current) measurements are used to validate the selected AI/ML model or (ii) the selected AI/ML model achieves the configured accuracy threshold level. The method may further comprise enabling the WTRU to validate AI/ML models with logged MDT measurements and/or (e.g., immediate/current) measurements. The method may further comprise selecting an AI/ML model for validation based on the indication of AI/ML model and configured selection criteria wherein if the conditional inference criteria (e.g., WTRU at specific location) is met, the method may comprise performing validation of the AI model and/or logging achieved AI/ML model accuracy level. Upon completion of the validation procedure, the method may comprise performing any of the following actions if the model accuracy level is below the configured accuracy threshold level: triggering transition to CONNECTED state, reporting AI/ML model identity, indicating that the accuracy level is below the threshold, and triggering/requesting training and validation process. Upon completion of the validation procedure, the method may comprise performing the following action if the model accuracy level is equal or above the configured accuracy threshold level: WTRU skips logged measurements.

In an embodiment, a method, implemented in a WTRU, for training AI/ML models with relevant dataset measurements, may comprise a step of receiving, from a network, a first message comprising information indicating a configuration for artificial intelligence/machine learning model training associated measurements. The first message may further comprise information indicating logging periodicity. In an embodiment, before receiving the first message, the method may comprise a step of transmitting, to the network, AI/ML capability information. The method may comprise a step of performing, in an idle state or in an inactive state, measurements configured for AI/ML model training. The method may further comprise a step of selecting an AI/ML model for training based on the first message; and a step of training the selected AI/ML model based on the performed measurements. The measurements configured for AI/ML model training may be of type of minimization of drive test measurements, MDT. In response to, or in case of, an accuracy level of the trained AI/ML model above a configured accuracy threshold level, the method may comprise a step of triggering transition to connected state, and a step of transmitting, to the network, a second message comprising information indicating an identity of the trained selected AI/ML model and AI/ML model parameters. The accuracy level of the AI/ML model may be determined based on the performed measurements.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communication system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a message flow diagram illustrating an example of a unidirectional radio resource control (RRC) signalling procedure for logged measurement configuration;

FIG. 3 is an example of a timeline for a legacy minimization of drive test (MDT) procedure;

FIG. 4 is a system diagram illustrating an example of neighbour cell prediction;

FIG. 5 is an example of a timeline for AI/ML model training operation at a WTRU.

FIG. 6 is an example of a timeline for AI/ML model validation operation at a WTRU; and

FIG. 7 is a flow chart illustrating an example of a method, implemented in a WTRU, for training AI/ML models with relevant dataset measurements.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

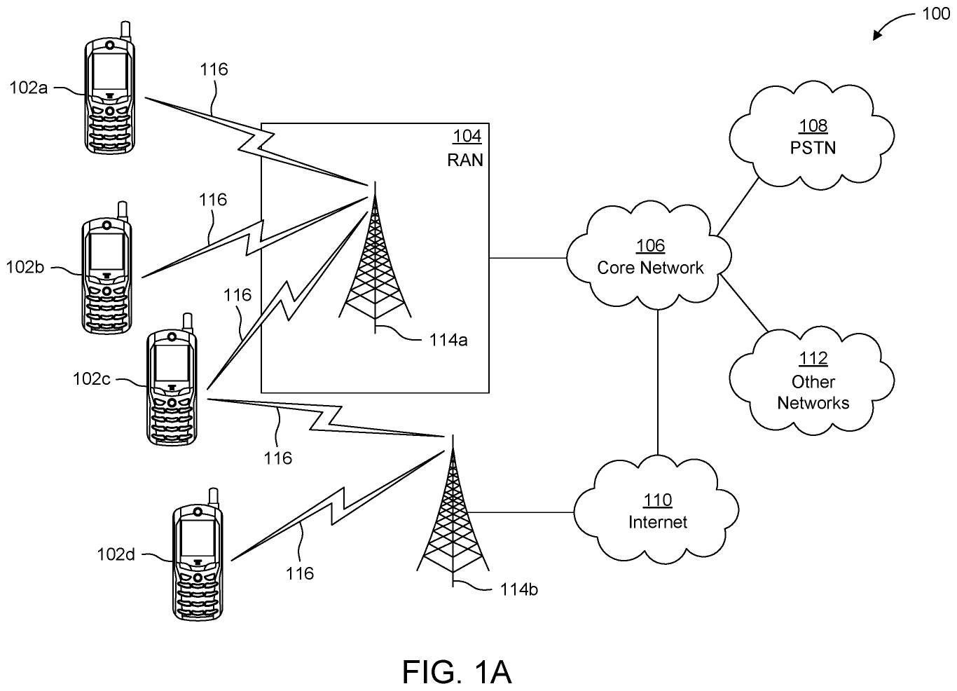

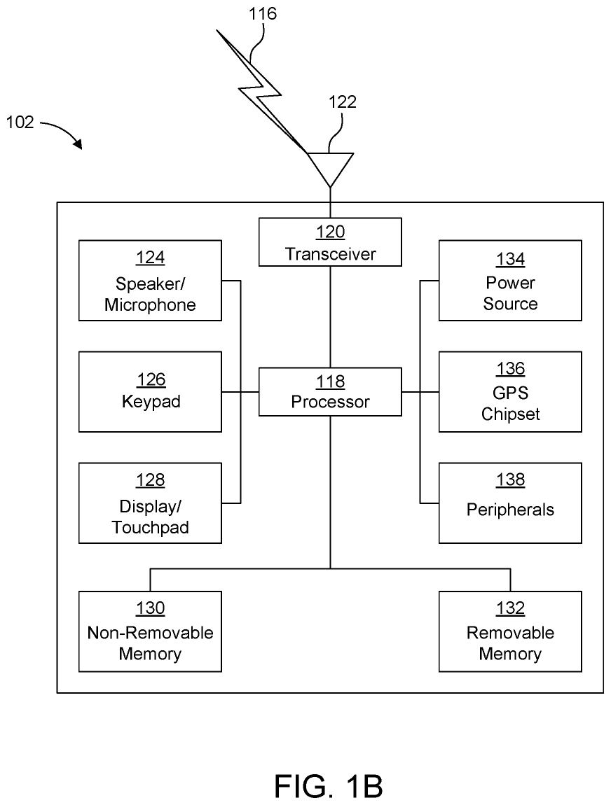

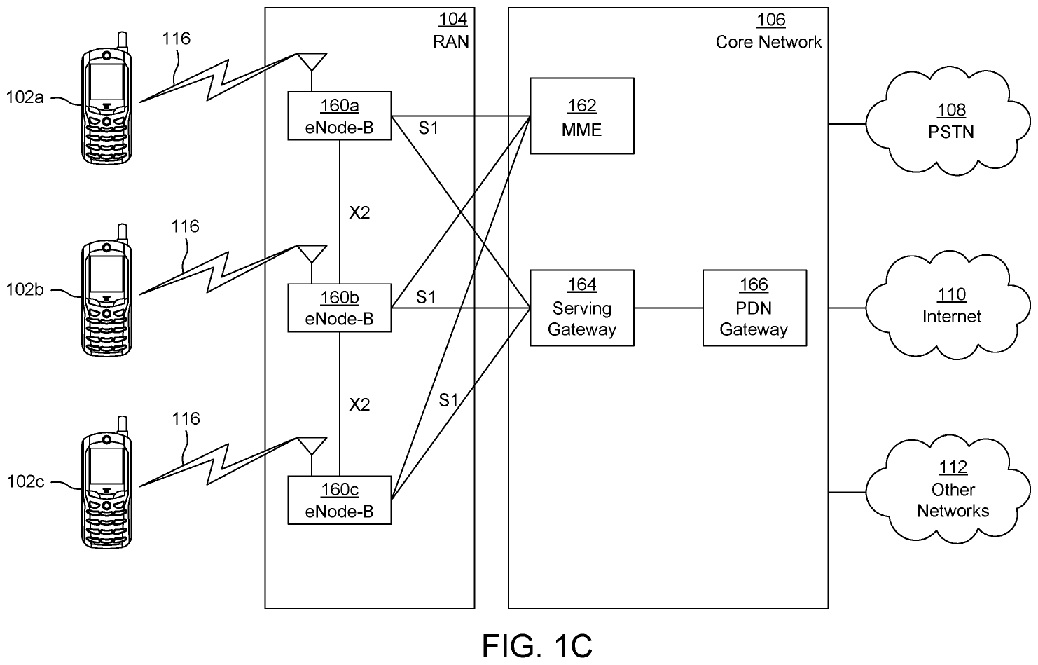

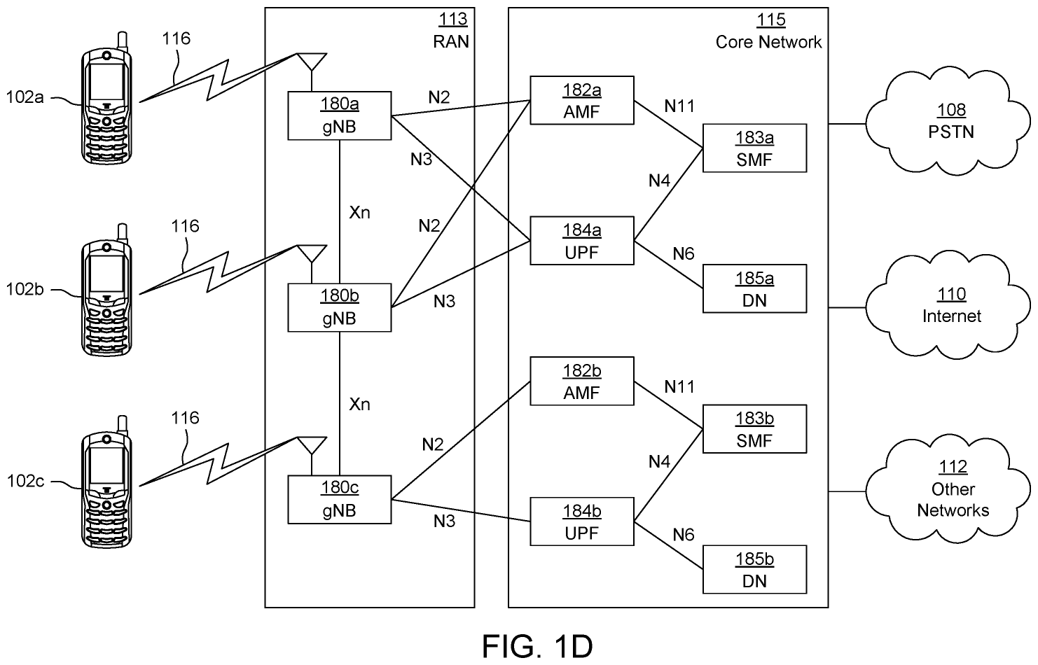

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80×80 configuration. For the 80×80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80×80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Example of Idle/Inactive Measurements

For WTRU in radio resource control idle state (RRC IDLE state) and RRC INACTIVE state, logged minimization of drive test (MDT) procedures are used. For logged MDT measurement collection for RRC INACTIVE WTRUs, the actual process of logging within the WTRU, may take place in RRC INACTIVE state and may be continued in RRC IDLE state; or vice versa. The logged measurement stored in WTRU during RRC INACTIVE and RRC IDLE state are kept for a given common period before they are deleted.

There are two types of logged MDT procedures defined, namely, signalling-and management-based. In the signalling based logged MDT, NG-RAN stores the logged MDT configuration in the WTRU context. However, in the management-based MDT, there is no such requirement. For both procedures, when WTRU resumes RRC connection in the last serving NG-RAN, the NG-RAN may configure the MDT for the WTRU.

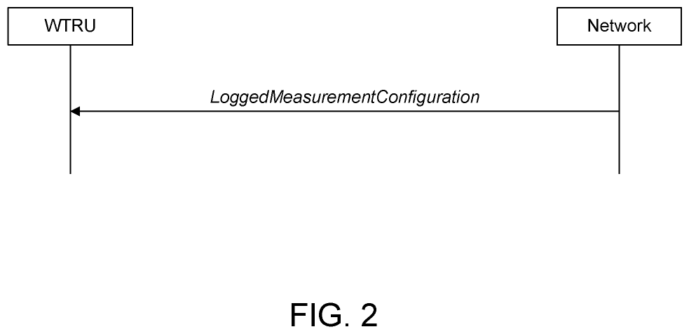

Referring to FIG. 2, a network may initiate a logged MDT procedure to WTRU in RRC Connected by sending LoggedMeasurementConfiguration message, which is used to transfer configuration parameters for logged MDT. This is a unidirectional RRC signalling procedure.

The logged MDT measurement configuration may include any of: triggering of logging events (periodic/event-based); logging duration; logging area; a list of neighbouring frequencies and/or cells; WLAN access point names; Bluetooth beacon names; and sensor names.

For downlink pilot strength measurements, the logged measurement report may consist of measurement results for a serving cell (measurement quantity), available WTRU measurements performed in idle or inactive for intra-frequency/inter-frequency/inter-radio access technology (RAT), time stamp and location information. The location information may be based on available location information in the WTRU. Hence, depending on the availability, measurement log may consist of time information and Radio-frequency (RF) measurements along with RF fingerprints or global navigation satellite system (GNSS) information or detailed location information based on sensor information.

There may be only one RAT-specific logged measurement configuration for logged MIDT in the WTRU. A release operation for logged measurement configuration in the WTRU may be realized only by configuration replacement when the configuration is overwritten or by configuration clearance in case a duration timer stopping or expiration condition is met. Logged measurements corresponding to the previous configuration will be cleared at the same time. It may be left up to the network to retrieve any relevant data before providing a new configuration.

WTRU may collect MDT measurements and may continue logging according to the logged measurement configuration until WTRU memory reserved for MDT is full. In this case, the WTRU may stop logging, stop the log duration timer and starts the 48-hour timer. The network may decide to retrieve the logged measurements based on this indication. In case logged MDT measurements are retrieved before the completion of the pre-defined logging duration, the reported measurement results may be deleted, but MDT measurement logging may continue according to ongoing logged measurement configuration. In case the network does not retrieve logged MDT measurements, WTRU should store non-retrieved measurements for 48 hours from the moment the duration timer for logging expired. There is no requirement to store non-retrieved data beyond 48 hours. In addition, all logged measurement configuration and the log shall be removed by the WTRU at switch off or detach. For logged MDT, the WTRU may include the indication in one of the RRC messages (RRCConnectionSetupComplete or RCSetupComplete or RRCConnectionResumeComplete or RRCResumeComplete) at every transition to RRC Connected mode even though the logging period has not ended. Then, the measurement reporting is triggered by an on-demand mechanism, e.g., the WTRU may be asked by the network to send the collected measurement logs via RRC signalling.

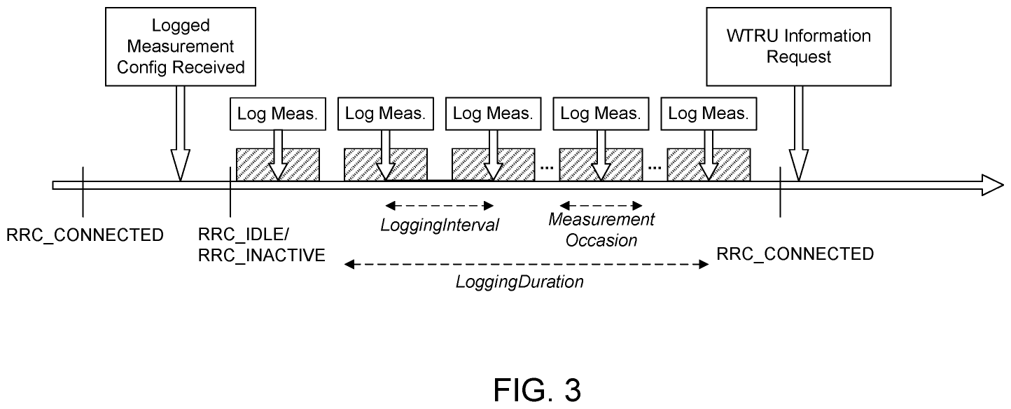

Referring to FIG. 3, a timeline for a legacy MDT procedure is shown. Accordingly, a network may initiate the MDT procedure to WTRU in RRC Connected by sending LoggedMeasurementConfiguration message, which is used to transfer configuration parameters for logged MIDT as depicted in FIG. 2. A release operation for logged measurement configuration in the WTRU may be realized (e.g., only) by configuration replacement when the configuration is overwritten or by configuration clearance in case a duration timer stopping or expiration condition is met. Logged measurements corresponding to the previous configuration will be cleared at the same time. It may be left up to the network to retrieve any relevant data before providing a new configuration.

A configuration of the triggering of logging events may include any of (i): periodic measurement trigger, for which the logging interval may be configurable, the parameter may specify the periodicity for storing MDT measurement results; and event-based trigger, for which the logging interval may be configurable, which may determine periodical logging of available data (e.g., time stamp, location information), and the following two types of events may be supported: (1) measurement quantity-based event L1, for which the event threshold, hysteresis, and time to trigger may be configurable. If the configured time to trigger is not a multiple of a discontinuous reception (DRX) cycle, then the WTRU may use the next multiple of DRX cycle duration that is larger than the time to trigger for evaluating the event L1; (2) out-of-coverage detection trigger.

A configuration of logging duration may include configuration of parameter defining a timer activated at the moment of configuration, that continues independent of state changes, RAT or registered public land mobile network (RPLMN) change.

According to the configuration of logging duration, when the timer expires, the logging may be stopped and the configuration may be cleared (except for the parameters that are required for further reporting e.g., network absolute time stamp, trace reference, trace recording session reference and trace collection entity (TCE) Id).

### Example of Mobility States/Scenario

A WTRU mobility state/scenario may be determined based on any of the parameters:
T_{CRmax}: specifies the duration for evaluating allowed amount of cell reselections.
N_{CR_M}/N_{CR_H}: specifies the maximum number of cell reselections to enter Medium/High-mobility state.
T_{CRmaxHsyt}: specific the maximum number of cell reselections to enter High-mobility state.

If these parameters are broadcasted in system information for the serving cell, any of the following state detection criteria may be followed:
Normal-mobility state criteria: if number of cell reselections during time period T_{CRmax} is less than N_{CR_M}.
Medium-mobility state criteria: If number of cell reselections during time period T_{CRmax} is greater than or equal to N_{CR_M} but less than or equal to N_{CR_H}.
High-mobility state criteria: If number of cell reselections during time period T_{CRmax} is greater than N_{CR_H}.

Mobility state is indicated as part of the RRCSetupComplete message in mobilityState IE, and it is indicated just prior to WTRU going into RRC_CONNECTED state.

### Example of Federated Learning and Transfer Learning

In federated learning, a central server may train a global model by aggregating local models partially-trained by each end devices. Within each training iteration, a WTRU may perform a training based on the model downloaded from the central server using the local training data. Then the WTRU may report the interim training results (e.g., gradients for the DNN) to the central server. The server aggregates the gradients from the WTRUs, and updates the global model. Next, the updated global model is distributed to the WTRUs. Then the WTRUs may perform the training for the next iteration.

In transfer learning, is a special case of federated learning, and the idea in transfer learning is to reuse a previously learned knowledge (previously trained AI/ML model) for another data set that may differ in the feature space of the already trained AI/ML model.

The difference between the federated learning and transfer learning is that the federated learning may make use of decentralized trained models with distributed data sets to train a global model whereas in the transfer learning, an already trained model (either trained locally or downloaded from a server) may be reused/retrained to predict another feature.

### Statement of Above Examples

For many AI/ML tasks, the fragmented data collected by mobile devices are essential for training a global model. For some AI/ML model training and model inference operations, input data may need to be consecutive and be a time series of information per certain granularity. In some cases, task and environment variations require a different AI/ML model to perform the same feature prediction. Therefore, another training and inference cycle may be needed with a different data set that represents the new environment variations. The current measurement reporting mechanisms may support AI/ML at network for training purposes. As the provided measurements data would be either non-consecutive or contain past measurements, the network needs to perform AI/ML training operation first, and then, performs the prediction/inference operation. Therefore, the legacy measurement procedures may not enable the network to perform predictions immediately after WTRU provided the measurements data. Nowadays, computation resources used in mobile devices can afford the execution of AI/ML operations at some capacity. In order to improve the AI/ML operations with these capable devices along with the existing or new set of measurements, the network may distribute the training operation to WTRUs that are capable to perform AI/ML operations. The network then may request WTRUs to provide trained model parameters that can be (e.g., immediately) aggregated by the network to have a global, use case-specific or area-specific AI/ML models which can be (e.g., immediately) used for prediction/inference by the network for the WTRUs that have the same or similar environment variations.

One issue example of the above described example is how to enhance the measurements and logging procedure to enable the network to efficiently utilize the available measurements at the WTRU by distributing/offloading the AI/ML training operation to WTRUs. The trained AI/ML models at the WTRU then can be used (e.g., immediately) by network to perform inference/predictions at the network side.

In the descriptions below the term AI/ML (Artificial Intelligence/Machine Learning) is used to describe any model and associated learning algorithm used by the WTRU or/and network to predict future behavior (in this disclosure, the behavior or data arrival at the WTRU to be sent to the network). The model and associated learning algorithm are assumed to utilize a set of data collected by the WTRUs and/or network.

The details about downloading an AI/ML model and the associated learning algorithm are outside the scope the description below, and the focus here is rather on the effective use of the already available AI/ML algorithms (either vendor-specific and/or downloaded from network/server) in the WTRU. Therefore, dependencies on required model size, its downloading latency, etc. are outside the scope of this disclosure.

In the description below, it is assumed that the WTRU's computation resource can afford the on-boarding process and execution of the AI/ML model operations including training and inference.

In the descriptions below, the terms “AI/ML model”, “AI model”, “ML model” and “model”are used interchangeably.

### Example of WTRU Transmitting AI/ML Capability Information

In an embodiment, the WTRU may indicate to the network its capability to perform AI/ML operations.

In an embodiment, the WTRU may indicate to the network its AI/ML capability separately for each AI/ML operation such as for AI/ML model training or AI/ML model validation or both of them.

In an embodiment, the WTRU may indicate to the network its capability according to legacy WTRU capability transfer (e.g., network sending a WTRUCapabilityEnquiry and WTRU responding with WTRUCapabilityInformation).

In an embodiment, the WTRU may indicate its AI/ML capability as part of a dedicated IE i.e., WTRUAIMLTrainingCapability, WTRUAIMLValidationCapability, WTRU-AI-Capability, etc. in the registration message during initial registration or registration update including WTRU-initiated, NW-initiated and periodic updates.

The proposed AI/ML capability information for both AI/ML model training and AI/ML model validation may be as simple as a binary “yes/no” or it may be a detailed one containing any of the following:
(i) Available AI models (e.g., vendor-specific AI models or already downloaded network-provided AI models). In some solutions, WTRU may include an ID associated with each AI model. For AI/ML model training: In case the AI model has already been downloaded from the home network (HPLMN) and no training has been performed yet, the WTRU may use the same ID provided by the network during the downloading process. In case the AI model has already been downloaded from the home network (HPLMN) and training has been performed, the WTRU may update the initially downloaded model ID in a predefined way dictated by the network. In case the AI model has already been downloaded from a visiting network (VPLMN), equivalent network (HPLMN), or private network including standalone (SNPN) and public network integrated (PNI-NPN) or an 3rd party server, and no training has been performed yet, the WTRU may use the same ID provided by the network that WTRU was connected to during the model download. Then, the WTRU's home network either finds out/matches the model ID by interacting with the network that provided the AI model or associates the model with an ID without any interaction. In case the AI model has already been downloaded from a visiting network (VPLMN), an equivalent network (HPLMN), or a private network including standalone (SNPN) or public network integrated (PNI-NPN) or an 3^{rd} party server, and the training has been performed at the WTRU, the WTRU may update the initially downloaded model ID in a predefined way dictated by the network that WTRU was connected to during the model download. Then, the WTRU's home network either finds out/matches the model ID by interacting with the network that provided the AI model or associates the model with an ID without any interaction. In case the AI model is a vendor-specific model, the WTRU may just provide model name or vendor-specific ID, and the network can associate the model with an ID.
(ii) Accuracy level of each available AI model.
(iii) AI computation capacity to perform training or validation (e.g., FLOPs). In various embodiments, the computation capacity may represent the overall capacity or current status of the remaining capacity. In an embodiment, the WTRU may also indicate whether it can perform more than one training and/or validation operation by utilizing the remaining computation capacity.
(iv) AI-dedicated memory capacity (e.g., for storing training/validation data and/or model storage). In various embodiments, the memory capacity can represent the overall capacity or current status of the remaining capacity. In an embodiment, the WTRU may use internal and external (e.g., SD card) storage capacity to store AI-related files (i.e., training data, validation data, model parameters, etc.).
(v) Time duration(s) where the training and/or validation may not be performed (e.g., this can be user preference such as during daytime, 08:00 to 18:00) or equivalently time duration(s) where the WTRU may perform training and/or validation. Possibly expressed as recommended time duration available for training and/or validation.
(vi) AI model switching capability/time to onboard (another existing) AI model (e.g., network may define various conditions that activate different AI model among the existing AI models at the WTRU).

### Example of AI/ML Configuration

In an embodiment, the WTRU may receive a configuration about AI/ML model training and/or AI/ML model validation.

In an embodiment, the WTRU may receive the AI/ML model training and/or validation configuration as a dedicated configuration (i.e., AIMLModelTrainingConfiguration or AIMLModelValidationConfiguration). Possibly in a RRC reconfiguration message. In an example, the WTRU may receive model training configuration as a part of MDT configuration.

In an embodiment, as the training and/or validation process requires a dataset/database, the WTRU may receive the AI/ML model training/validation configuration as part of a legacy measurement configuration (i.e., LoggedMeasurementConfiguration, measConfig).

The proposed AI/ML model training and/or validation configuration may be a detailed one containing any of the following:
(i) Indication of AI model(s) (e.g., already available as vendor-specific or network provided). In various embodiments, the AI model ID may be used to indicate the AI model(s). Possibly the AI model ID may occupy a preconfigured number space allocated for the specific vendor. For example, the model ID may be determined as a combination of one or more of the following: country ID, vendor ID, device/firmware/execution environment ID, model class ID, model version ID etc.
(ii) Selection criterion/criteria for AI model(s). In an embodiment, selection criterion/criteria may include mobility state/scenario of the WTRU. For example, one AI model may be used when the WTRU's mobility state is determined as normal-mobility, and another AI model may be used when the WTRU's mobility state is determined as high-mobility. Various other criteria such as WTRU not-at-cell-edge, etc., may be also considered individually or in a combined way for the selection of the AI model(s).
(iii) Associated measurements. In an embodiment, the associated measurements may be provided as an individual parameter based on the WTRU's measurement capabilities. In an embodiment, the associated measurements may be provided as a set of parameters based on the WTRU's measurement capabilities. In an embodiment, the granularity of the associated measurements may be indicated as part of the configuration. In an embodiment, the filtering type/averaging window of the associated measurements may be indicated as part of the configuration.
(iv) Input/output parameters. In an embodiment, the input parameter(s) may be part of the associated measurements. Note that the associated parameters do not have to be the input parameters of the AI/ML model training/validation. Some of the associated parameters may be used for the lifecycle management of the AI/ML model and/or AI/ML model training/validation process. In an embodiment, the output parameter(s) and expected format/size/length (in case for time series predictions) may be indicated.
(v) Loss/Reward function. Depending on the AI/ML model to be used, the network may provide the loss or reward function associated with the AI/ML model to be trained and/or validated.
(vi) Accuracy threshold. In an embodiment, an accuracy threshold may be defined by network. For AI/ML model training, the accuracy threshold then may be used to trigger/stop the model training process as detailed below. For AI/ML model validation, the accuracy threshold may be used to trigger WTRU to report validation output to the network as detailed below. In an embodiment, the accuracy threshold may be used to trigger WTRU to report trained model parameters and/or validation output to the network as detailed below.
(vii) Training and/or validation data configuration (e.g., minimum dataset size for training/validation, AI/ML-model specific data batch size). In an embodiment, a training and/or validation data configuration may be provided by the network to indicate required dataset size for training and/or validating a specific AI/ML model. This specific AI/ML model may be a network provided model. In an embodiment, a training and/or validation data configuration may be provided by the network to specify the batch size of the dataset required for a specific AI/ML model. In an embodiment, a training and/or validation data configuration may be provided by the network to indicate specific attributes available in the associated measurements or training and/or validation dataset.
(viii) Conditional logging configuration (e.g., based on AI model accuracy). In an embodiment, a conditional logging configuration may be indicated by network as part of the AI/ML model training and/or validation configuration. The conditional logging configuration can be based on achieved AI model accuracy and can be used by WTRU to whether skip the logging of the measurements or not as detailed below. In an embodiment, the conditional logging configuration may be indicated by network as a new information element (IE) within the legacy measurement configurations (e.g., LoggedMeasurementConfiguration, MeasConfig). In an embodiment, the conditional logging configuration may be indicated by network to enable WTRU to log not only logged MDT measurements but also (e.g., current/immediate) MDT as well as connected mode measurements as detailed below.
(ix) Conditional training/validation configuration (e.g., based on specific location). In an embodiment, a conditional training and/or validation configuration may be indicated by network. The conditional training/validation configuration may be based on a specific location and may be used by WTRU to trigger/stop the measurement logging process and/or model training/validation process as detailed below.
(x) Training/validation timer. In an embodiment, an AI/ML model training and/or validation timer may be indicated by the network. The AI/ML model training and/or validation timer may be configured by network based on a specific timeline to receive the trained model updates and/or model validation output/result, or based on the computation capabilities of the WTRU in order to not to overload the WTRU with the AI/ML model training and/or validation task(s) in case the expected accuracy level has not been achieved by the given training/validation timer as detailed below. In an embodiment, the AI/ML model training/validation timer may be used to stop/halt the training/validation process running at the WTRU. In an embodiment, the AI/ML model training/validation timer may be used to remove stored AI/ML model(s)/parameters or stored dataset for training of the specific AI/ML model(s) or stored AI/ML model(s) output/achieved accuracy level as detailed below.
(xi) Training parameter (e.g., model hyperparameter)

In one embodiment if there is a need to specify a model parameter, a model hyperparameter that controls the training (also known as training parameter) may be provided by the network. The model hyperparameter may be provided as part of the input parameters or as a dedicated IE in the AI/ML model training configuration.

### Example of AI/ML Operation-Specific Measurement Logging

According to the usage of available measurements at the WTRU for AI/ML model training and/or validation, legacy measurement procedures may be used. Accordingly, the WTRU may perform logged MDT measurements, (e.g., immediate/current) MDT measurements as well as connected mode measurements.

In an embodiment, the WTRU may have different datasets for the AI/ML model training and AI/ML model validation if the WTRU is configured to perform both operations at the same time. These different datasets may be stored separately.

In an embodiment, the WTRU may use the same dataset for the AI/ML model training and validation operation if the WTRU is configured to perform both operations either at the same time or at different time periods.

In an embodiment, not only the logged MDT measurements but also (e.g., immediate/current) MDT measurements and connected mode measurements may be logged by the WTRU to create the required dataset for the AI/ML model training and/or validation.

In an embodiment, the (e.g., immediate/current) MDT measurements and/or connected mode measurements for the AI/ML training and/or validation process may be logged and stored in the WTRU's memory reserved for the logged MDT measurements storage.

In an embodiment, the (e.g., immediate/current) MDT measurements and/or connected mode measurements for the AI/ML training and/or validation process may be logged and stored in the WTRU's memory reserved for or indicated as AI-dedicated memory.

In an embodiment, if the WTRU is configured to perform AI/ML model training and/or validation, the logged MDT measurements may be logged and stored in the WTRU's AI-dedicated memory instead of the WTRU's memory reserved for the logged MDT measurements.

In an embodiment, the logged MDT measurements for the AI/ML training and/or validation process may be logged and stored in the WTRU's memory reserved for as the legacy way and also logged in the WTRU's AI-dedicated memory.

In an embodiment, any measurement including logged MDT, intermediate MDT and connected mode measurements to be stored in the AI-dedicated memory, the dataset batch size provided as part of the training/validation data configuration may be used to store the measurements.

In an embodiment, any measurement including logged MDT, intermediate MDT and connected mode measurements to be stored in the AI-dedicated memory, the WTRU may only store the specific attributes provided as part of the training and/or validation data configuration.

In an embodiment, any measurement including logged MDT, intermediate MDT and connected mode measurements to be stored in the AI-dedicated memory, the WTRU may stop storing them in case the required training dataset size provided as part of the training/validation data configuration has been achieved.

In an embodiment, in case the conditional logging configuration is provided as part of the AI/ML training and/or validation configuration, the WTRU may skip a measurement logging occasion when any of the following conditions are met: AI/ML model is still in the training/validation phase with the existing logged measurements data; and/or the (e.g., immediate/current) measurements are used to determine the trained accuracy level of the AI/ML model; and/or the (e.g., immediate/current) measurements are used to validate the trained accuracy level of the AI/ML model; and/or the trained AI/ML model achieves the configured accuracy threshold level and/or the condition provided as part of the conditional training/validation configuration is not met.

In an embodiment, in case the required AI/ML model accuracy threshold is not achieved for a given training/validation timer, the WTRU may decide to remove/delete the stored dataset for the training/validation. Deletion of the stored training/validation dataset may be followed by any of: WTRU to report to network that the AI/ML model training/validation cannot achieve the given accuracy threshold; and WTRU to perform measurements, create new dataset based on the given associated measurements and restart the training/validation timer.

### Example of WTRU Performing AI/ML Operation

In an embodiment, the WTRU may select an AI model for training and/or validation based on the indicated AI model as part of the AI/ML model training configuration.

In an embodiment, the WTRU may be configured with plurality of AI models and a selection criterion associated with each AI model. For example, the selection of the AI model may also depend on the configured selection criterion/criteria provided as part of the model training and/or validation configuration. Accordingly, the selection of the AI model may be based on one criterion or combination (AND/OR statements) of any of the following criteria: WTRU's mobility state/scenario as normal-mobility; WTRU's mobility state/scenario as medium-mobility; WTRU's mobility state/scenario as high-mobility; WTRU detected as not-at-cell-edge; WTRU detected as cell edge; WTRU's mobility state/scenario as normal-mobility and UE detected as not-at-cell-edge; WTRU's mobility state/scenario as normal-mobility or UE's mobility state/scenario as medium-mobility; and etc.

In order to use some of the criteria noted above, the mobility state may not (e.g., only) just be evaluated prior to WTRU going into RRC_CONNECTED state but also during RRC_IDLE or RRC INACTIVE states. Therefore, in an embodiment, the WTRU may perform the mobility state evaluation periodically while it is either in RRC_IDLE or RRC INACTIVE state. The WTRU may not periodically report the mobility state evaluation during RRC_IDLE or RRC INACTIVE states. The WTRU may keep the last mobility state evaluation as an IE as part of the WTRU Information, and may provide mobility state evaluation during RRC_IDLE or RRC_INACTIVE state.

Once the WTRU selects an AI/ML model, the WTRU may start performing AI/ML model training and/or validation when one or more of the following conditions are met.
(i) The logged measurement data (idle/inactive/connected mode measurements) either at the WTRU's AI-dedicated memory or WTRU's memory reserved for storing measurements as the legacy way meets the training and/or validation data configuration provided as part of the AI/ML training/validation configuration. In an embodiment, the WTRU may check the dataset volume available in the WTRU's AI-dedicated memory or WTRU's memory reserved for storing measurements. If the dataset volume is larger than the configured minimum dataset size for training/validation, the WTRU may start to perform AI/ML model training/validation operation. In an embodiment, once the configured minimum dataset size for training is met, the WTRU may divide the data based on the given training and/or validation batch size as part of the training data configuration. In an embodiment, the WTRU may check the dataset volume available in the WTRU's AI-dedicated memory or WTRU's memory reserved for storing measurements. If the dataset volume is larger than the configured training/validation batch size, the WTRU may start to perform AI/ML model training/validation operation. In the meantime, WTRU may keep logging the measurements until the configured minimum dataset size for training and/or validation is met.
(ii) The condition(s) provided as part of the conditional training and/or validation criteria. In an embodiment, location may be provided as the conditional training/validation criteria. The location may be indicated as a: range of coordinates, physical cell ID, Tracking area, etc.

In an embodiment, WTRU's battery status may be provided as the conditional training and/or validation criteria. If the WTRU's battery status is above the given conditional threshold, the WTRU may perform AI/ML model training and/or validation.

In an embodiment, once the training and/or validation process has started at the WTRU and the conditions noted above are not met anymore (e.g., the WTRU is not at the given location): In case the AI/ML operation is AI/ML model training, the WTRU may stop the training process, log the trained model parameters that achieves the maximum accuracy level along with the achieved accuracy level; and in case the AI/ML operation is AI/ML model validation, the WTRU may stop the validation process and log the maximum accuracy level.

In an embodiment, once the training and/or validation process has started at the WTRU and the conditions noted above are not met anymore (e.g., the WTRU is not at the given location), the WTRU may stop logging measurements data. In case, the condition regarding the training and/or validation data size has met, the WTRU may continue the training and/or validation process even if the location condition is not met.

In an embodiment, once the WTRU starts performing AI/ML model training and/or validation, WTRU may start the training and/or validation timer.

In an embodiment, while WTRU performs the AI/ML model training, the WTRU may log the trained AI/ML model parameters along with the achieved accuracy. The WTRU may log the trained AI/ML model parameters and the achieved accuracy after completion of each epoch to the WTRU's AI-dedicated memory.

In an embodiment, during the training process, if the WTRU trained AI/ML model achieves the given accuracy threshold, WTRU may stop the training process and logs the trained model parameters along with the achieved accuracy to the WTRU's AI-dedicated memory.

In an embodiment, during the validation process, if the given AI/ML model achieves the given accuracy threshold, WTRU may stop the validation process and may log the achieved accuracy to the WTRU's AI-dedicated memory.

In an embodiment, if the WTRU trained AI/ML model cannot achieve the given accuracy threshold for the given training time, the WTRU may stop training process and log the trained model parameters that achieves the maximum accuracy level along with the achieved accuracy level to the WTRU's AI-dedicated memory.

In an embodiment, if the given trained AI/ML model cannot achieve the given accuracy threshold for the given validation time, the WTRU may stop validation process and log the achieved accuracy level to the WTRU's AI-dedicated memory.

In an embodiment, if the WTRU trained AI/ML model cannot achieve the given accuracy threshold by expiry of the given training and/or validation time, WTRU may remove the AI/ML model from its AI-dedicated memory or logged measurements or training and/or validation dataset.

### Example of WTRU Reporting

### Reporting for AI/ML Model Training

In an embodiment, in case the trained AI/ML model at the WTRU achieves the given accuracy threshold provided as part of the AI/ML training configuration, the WTRU may switch from idle/inactive state to connected state in order to report the AI/ML model(s) identity, trained AI/ML model(s) parameters and the achieved threshold level(s).

In an embodiment, once the trained AI/ML model(s) at the WTRU achieves the given accuracy threshold provided as part of the AI/ML training configuration, the WTRU may switch from idle/inactive state to connected state in order to indicate to the network that the training process(es) is(are) completed with the given accuracy threshold(s). The WTRU may receive from the network a request to collect trained AI/ML model(s) parameters.

In an embodiment, the WTRU may receive a request from the network, wherein the network may not have the information on the status of the training at the WTRU. The WTRU may: (i) still performing the AI/ML model(s) training and may send a status regarding the training such as the maximum achieved accuracy level(s); and/or completed the AI/ML model(s) training and may send the trained AI/ML model(s) identity that achieves the given accuracy threshold level(s) provided as part of the AI/ML training configuration along with the trained AI/ML model parameters.

In an embodiment, the WTRU may report logged validity time of the trained AI/ML model(s) that achieves the given accuracy threshold level. The logged validity time may differ for WTRU's mobility state/scenario. For example, if the WTRU is at normal-mobility, the predictions that would be provided by the trained AI/ML model may valid for a certain time period. The trained model at a WTRU that is at high-mobility may achieve shorter validity period.

In an embodiment, the network may use the validity time to decide whether the trained AI/ML model at the WTRU should be fetched or not.

In an embodiment, in case the WTRU trained AI/ML model accuracy is below the configured accuracy threshold within the given training time, the WTRU may report the achieved maximum AI/ML model accuracy to the network. The WTRU may also report the training dataset/logged measurements that is used to train the AI/ML model. The WTRU may receive from the network a request to fetch the trained AI/ML model parameters. The WTRU may receive from the network a request to fetch the training dataset/logged measurements.

### Reporting for AI/ML Model Validation

In an embodiment, in case the given trained AI/ML model to the WTRU achieves the given accuracy threshold provided as part of the AI/ML validation configuration, the WTRU may switch from idle/inactive state to connected state in order to report the AI/ML model(s) identity and the validation output(s)/achieved threshold level(s).

In an embodiment, once the given trained AI/ML model(s) to the WTRU achieves the given accuracy threshold provided as part of the AI/ML validation configuration, the WTRU may switch from idle/inactive state to connected state in order to indicate to the network that the validation process(es) is(are) completed as the given accuracy threshold(s) is achieved. The WTRU may receive from the network a request to collect the validation output(s).

In an embodiment, the WTRU may receive from the network a request, wherein the network may not have the information on the status of the validation at the WTRU. The WTRU may: still performing the AI/ML model(s) validation and may send a status regarding the validation such as the maximum achieved accuracy level(s); and/or completed the AI/ML model(s) validation and may send the given trained AI/ML model(s) identity that achieves the given accuracy threshold level(s) provided as part of the AI/ML validation configuration along with the validation output(s)/accuracy levels.

In an embodiment, the WTRU may report logged validity time of the given trained AI/ML model(s) that achieves the given accuracy threshold level. The logged validity time may differ for WTRU's mobility state/scenario. For example, if the WTRU is at normal-mobility, the predictions that would be provided by the given trained AI/ML model may valid for a certain time period. The given trained model to a WTRU that is at high-mobility may achieve shorter validity period.

In an embodiment, the network may use the validity time to decide whether the given trained AI/ML model to the WTRU should be used or not for the WTRUs that are in similar condition(s)/location or reporting similar measurement results.

In an embodiment, in case the given trained AI/ML model accuracy is below the configured accuracy threshold within the given validation time, the WTRU may report the achieved maximum AI/ML model accuracy to the network. The WTRU may also report the validation dataset/logged measurements that is used to validate the AI/ML model. The WTRU may receive from the network a request to fetch the validation dataset/logged measurements.

In an embodiment, if the given trained AI/ML model cannot achieve the given accuracy threshold by expiry of the given validation time and the WTRU has a capability to perform AI/ML model training, the WTRU may indicate its AI/ML training capability to the network. The network may initiate a re-training process at the WTRU for the given trained AI/ML model.

### Exemplary Figures

### Example Use Case Figure: Neighbour Cell Prediction

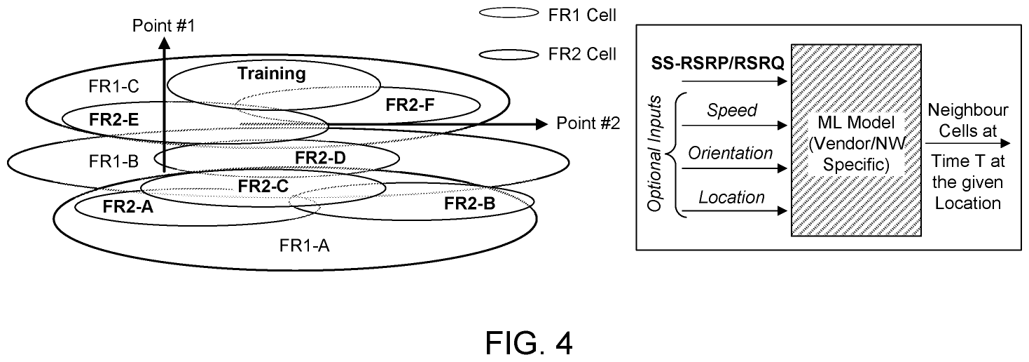

Referring to FIG. 4:

Network may configure WTRUs that support AI/ML operations to train neighbour cell prediction model depending on their mobility scenario and/or location. Network may provide a pre-trained (global) model to WTRU (transfer learning) to have the model training with local measurements. WTRU may support multiple AI/ML model configurations. Depending on the WTRU's status, WTRU/network may decide the AI/ML model configuration.

WTRU may train AI/ML model for intra-/inter-frequency neighbour cell prediction (training may happen only while the WTRU is inside a given area)

Depending on the WTRU's mobility scenario such as low/high mobility, not-at-cell-edge etc. the trained model at WTRU may provide different inference output (with different accuracy level) at different points shown as point #1 and point #2. At point #1, serving cell is FR1-B and a neighbour cell prediction may not include FR2 cells for a user with high-mobility. However, for a low-mobility user, FR2 cells C and D may be predicted as neighbour cells. At point #2, serving cell is FR2-E and a neighbour cell prediction may include FR2 cells D and F, and FR1 cells C and B for users with both high-mobility and low-mobility scenarios. Trained models at low mobility WTRUs may achieve longer validity period for the predictions based on their trained models. Whereas trained models at high mobility WTRUs may support relatively shorter validity periods. Trained models at low mobility WTRUs may achieve a given accuracy level quicker than high mobility WTRUs whereas high mobility WTRUs may need longer training period to achieve a given accuracy threshold to provide the trained model parameters to network.

Network may use WTRU's trained model to predict WTRUs neighbour cell list for the same area based on measurements from any WTRU including legacy WTRUs. WTRU's trained model may be applicable to other WTRUs with the same/similar mobility scenarios.

### AI/ML Model Training at WTRU

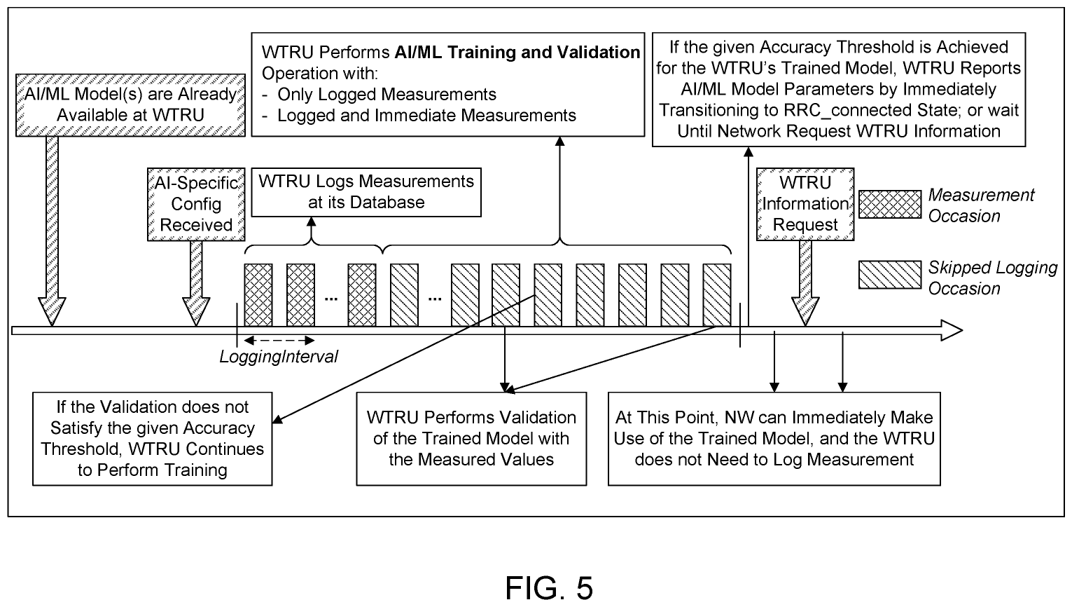

FIG. 5 depicts an example of AI/ML model training operation at the WTRU.

Referring to FIG. 5, it is assumed that various AI/ML models may be (e.g., already) available at the WTRU. Once the WTRU receives AI/ML training configuration, the WTRU may start logging measurements to create a training database based on the given training database configuration. Depending on the given training database configuration and/or required measurements, the WTRU may log (e.g., immediate/current) measurements to its AI-dedicated memory. Once the database size provides the given training database size as part of the training configuration, the WTRU may not log further measurements and starts AI/ML training operation. In (e.g., each) training epoch, the WTRU may check the accuracy threshold of the trained model. If the validation does not satisfy the given threshold, the WTRU may continue to perform training. During the training and validation phase, if the given accuracy threshold is achieved for the recently trained model at the WTRU, the AI/ML model parameters along with any parameters that is requested as part of the AI/ML training configuration may be provided to the network by the WTRU either (i) (e.g., immediately/currently) transitioning to RRC connected state; or (ii) waiting until the WTRU receives from the network information request message. Once the WTRU provides the trained AI/ML model parameters to the network, the network may (e.g., immediately/currently) make use of the trained model inference/predictions for the WTRUs that have similar traffic and/or mobility and/or etc.

### AI/ML Model Validation at WTRU

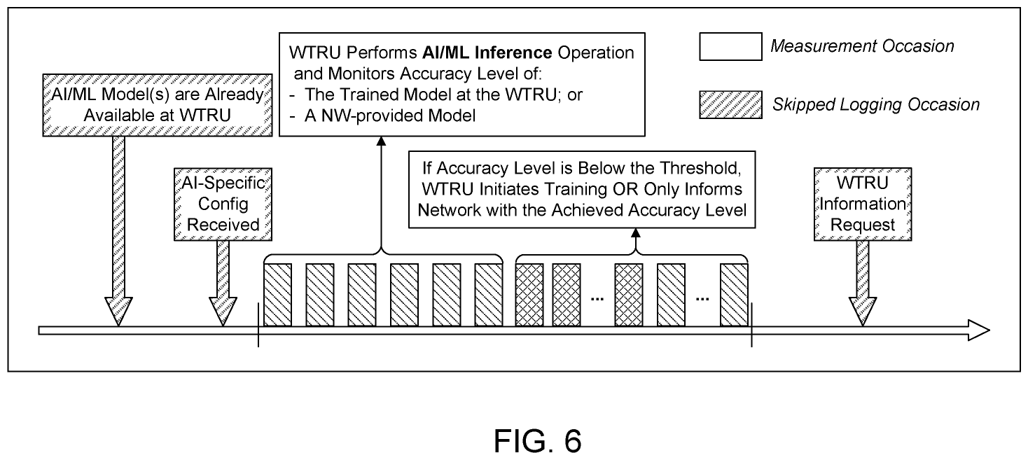

FIG. 6 depicts an example of AI/ML model validation operation at the WTRU.

Referring to FIG. 6, it is assumed that various AI/ML models are already available at the WTRU. Once the WTRU receives AI/ML validation configuration, the WTRU may start performing AI/ML validation operation. During the validation operation, the WTRU may perform inference with the chosen AI/ML model and monitors the accuracy level of the inference output. If the network is not interested with the measured and predicted values, the WTRU may not log the measured and predicted values during the validation process. In case the accuracy level of the AI/ML model inference is below the threshold then, if the network enables the WTRU to perform training when the accuracy threshold is not achieved, the WTRU may initiate AI/ML model training based on the given AI/ML configuration including validation as well as training; or the WTRU may inform network with the achieved accuracy level either by transitioning to RRC connected state to report or waiting until the network sends the WTRU information request message.

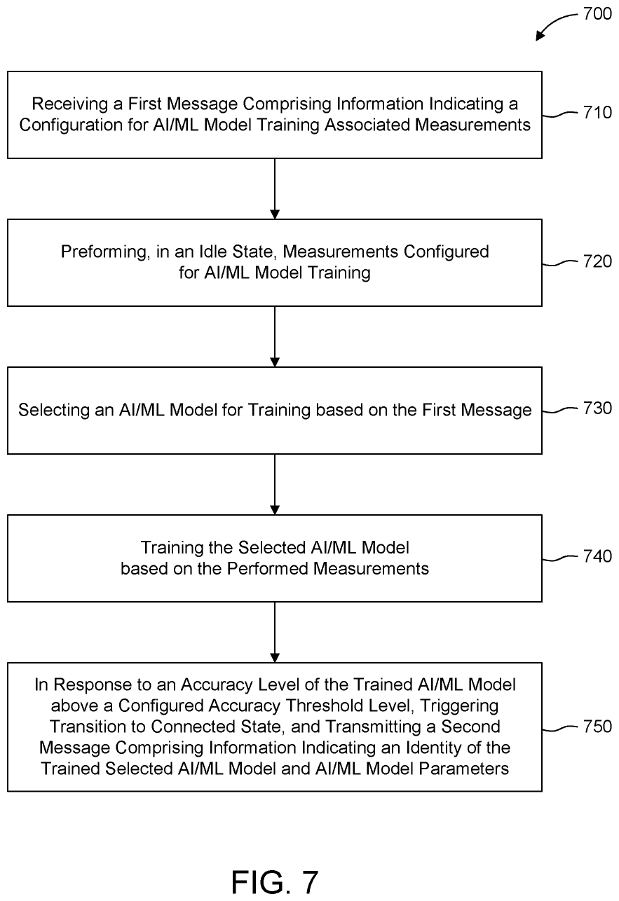

Referring to FIG. 7, in an embodiment, a method 700, implemented in a WTRU, for training AI/ML models with relevant dataset measurements, may comprise a step of receiving 710, from a network, a first message comprising information indicating a configuration for artificial intelligence/machine learning, AI/ML, model training associated measurements. The first message may further comprise information indicating logging periodicity. In an embodiment, before receiving the first message, the method 700 may comprise a step of transmitting, to the network, AI/ML capability information. The method 700 may comprise a step of performing 720, in an idle state or in an inactive state, measurements configured for AI/ML model training. The method 700, may further comprise a step of selecting 730 an AI/ML model for training based on the first message; and a step of training 740 the selected AI/ML model based on the performed measurements. The measurements configured for AI/ML model training may be of type of minimization of drive test measurements, MDT. In response to, or in case of, an accuracy level of the trained AI/ML model above a configured accuracy threshold level, the method 700 may comprise a step of triggering 750 transition to connected state, and a step of transmitting, to the network, a second message comprising information indicating an identity of the trained selected AI/ML model and AI/ML model parameters. The accuracy level of the AI/ML model may be determined based on the performed measurements.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C. § 112, 16 or means-plus-function claim format, and any claim without the terms “means for” is not so intended.

1. A method implemented by a wireless transmit receive unit (WTRU) comprising:
receiving, from a network, a first message comprising first information indicating a configuration for artificial intelligence/machine learning, AI/ML, model training, and for measurements for AI/ML training, wherein the configuration for AI/ML model training comprises second information indicating any of one or more AI/ML models, one or more AI/ML selection criteria, a training data configuration, a conditional logging configuration, and a conditional training configuration;
performing, in an idle state, measurements configured for AI/ML model training;
selecting an AI/ML model for training based on the first message;
training the AI/ML model based on the performed measurements; and
in response to an accuracy level of the trained AI/ML model above a configured accuracy threshold level, triggering transition to connected state, and transmitting, to the network, a second message comprising third information indicating an identity of the trained AI/ML model and one or more AI/ML model parameters.

2. The method of claim 1, wherein the accuracy level of the trained AI/ML model is determined based on the performed measurements.

3. The method of claim 1, comprising:
prior to receiving the first message, transmitting, to the network, AI/ML capability information.

4. The method of claim 3, wherein the AI/ML capability information includes any of one or more available AI/ML models, one or more accuracy levels of the one or more available AI/ML models, a computation capability for training, a computation capability for validation, and an AI/ML-dedicated memory capacity.

5-6. (canceled)

7. The method of claim 1, wherein the measurements configured for AI/ML model training are of a type of minimization of drive test (MDT) measurements.

8. The method of claim 7, wherein performing the measurements configured for AI/ML model training comprises:
logging legacy MDT measurements or skipping MDT measurement logging occasion when one or more of the following conditions are met: (i) the AI/ML model is still in a training phase with existing logged MDT measurements data; (ii) current MDT measurements are used to validate the trained AI/ML model or (iii) the trained AI/ML model achieves the configured accuracy threshold level.

9. The method of claim 7, wherein in response to logged MDT measurement data meeting the training data configuration and if one or more training criteria is met, the method comprising:
performing training of the AI/ML model; and
logging the one or more AI/ML model parameters.

10. The method of claim 1, comprising:
receiving an AI/ML model from the network.

11. The method of claim 1, wherein selecting an AI/ML model for training based on the first message comprises selecting the AI/ML model based on an indication of an AI model and the one or more AI/ML selection criteria.

12. The method of claim 1, wherein in response to the accuracy level of the trained AI/ML model equal or below the configured accuracy threshold level, the method comprising:
reporting one or more logged measurements and a maximum trained AI/ML model accuracy level achieved during training.

13. A wireless transmit/receive unit (WTRU) comprising a processor, a transceiver unit and a storage unit, and configured to:
receive, from a network, a first message comprising first information indicating a configuration for artificial intelligence/machine learning, AI/ML, model training, and for measurements for AI/ML training, wherein the configuration for AI/ML model training comprises second information indicating any of one or more AI/ML models, one or more AI/ML selection criteria, a training data configuration, a conditional logging configuration, and a conditional training configuration;
perform, in an idle state, measurements configured for AI/ML model training;
select an AI/ML model for training based on the first message;
train the AI/ML model based on the performed measurements; and
in response to an accuracy level of the trained AI/ML model above a configured accuracy threshold level, trigger transition to connected state, and transmit to the network a second message comprising third information indicating an identity of the trained AI/ML model and one or more AI/ML model parameters.

14. The WTRU of claim 13, wherein the accuracy level of the trained AI/ML model is determined based on the performed measurements.

15. The WTRU of claim 13, configured to:
transmit, to the network, AI/ML capability information.

16. The WTRU of claim 15, wherein the AI/ML capability information indicates any of one or more available AI/ML models, one or more accuracy levels of the one or more available AI/ML models, a computation capability for training, a computation capability for validation, and an AI/ML-dedicated memory capacity.

17-18. (canceled)

19. The WTRU of claim 13, to wherein the measurements configured for AI/ML model training are of a type of minimization of drive test (MDT) measurements.

20. The WTRU of claim 19, configured to:
log legacy MDT measurements or skip MDT measurement logging occasion when one or more of the following conditions are met: (i) the AI/ML model is still in a training phase with existing logged MDT measurements data; (ii) current MDT measurements are used to validate the trained AI/ML model or (iii) the trained AI/ML model achieves the configured accuracy threshold level.

21. The WTRU of claim 19, and configured to, in response to logged MDT measurement data meeting the training data configuration and if one or more AI/ML training criteria is met:
perform training of the AI/ML model; and
log the one or more of AI/ML model parameters.

22. The WTRU of claim 13, configured to:
receive an AI/ML model from the network.

23. The WTRU of claim 13, to wherein being configured to select the AI/ML model for training based on the first message comprises being configured to select the AI/ML model based on an indication of a AI model and the one or more AI/ML selection criteria.

24. The WTRU of claim 13, configured to:
in response to the accuracy level of the AI/ML trained model equal or below the configured accuracy threshold level, report one or more logged measurements and a maximum trained AI/ML model accuracy level achieved during training.
